(19) United States
(12) Patent Application Publication
(10) Pub. No.: US 2008/0211799 A1
(43) Pub. Date: Sep. 4, 2008

(54) DRIVING MECHANISM FOR THICK LIQUID CRYSTAL CELL

(76) Inventor: Cheng-Hsing Liao, Hsinchu (TW)

Correspondence Address: GIFFORD, KRASS, SPRINKLE,ANDERSON & CITKOWSKI, P.C, PO BOX 7021, TROY, MI, 48007-7021, US

(21) Appl. No.: 11/959,858

(22) Filed: Dec. 19, 2007

(30) Foreign Application Priority Data
Dec. 20, 2006 (TW) 095148023

(51) Int. Cl. G09G 5/00

(52) U.S. Cl. 345/211

(57) ABSTRACT

An optimized driving method for thick liquid crystal cavity rap (thick cell) type liquid crystal panel, that is used for common electrode driving of liquid crystal display (LCD) panel, wherein a second DC or AC adjustable-period or tunable power source is applied to drive the common electrode of the LCD panel so as to minimize voltage excursion without having to change signal, and wherein data signals pass through TFT-type data driver, thereby making the work function between the aluminum metallic layer and the electrode of liquid crystal display panel to be near a stable state to avoid quality problems associated with image flickering.

### CROSS-REFERENCE TO RELATED APPLICATIONS

This application claims priority of Taiwan Patent Application No. 095148023 filed Dec. 20, 2006.

### FIELD OF THE INVENTION

This invention relates to a method, and in particular, to a common electrode used for thick liquid crystal cavity gap (thick cell) type LCD panels, and a driving method for optimizing the image display quality of display panels by inputting a second DC or AC adjustable-period or tunable power source to the common electrode.

### BACKGROUND OF THE INVENTION

Liquid crystals are extensively used in display products, and provide luminous on-off function through apply voltage to electrodes on two sides. Usually, the thickness of known liquid crystal layer between two electrodes is very thin. For example, in the case of TFT type LCD panels, the thickness is between 6 μm to 8 μm; in the case of TN or STN type LCD panels, the liquid crystal layer and gap is below 10 μm; and in the case of LCOS micro display, the average thickness of liquid crystal layers is about 3 μm to 5 μm.

The driving features of known thin liquid crystal panels are summarized as follows.
1. Firstly, the basic requirements: higher clairvoyance rate, suitable liquid crystal cavity gap thickness and double refraction rate (Phasic Delay=dΔN) are required, so that LCD panel devices can achieve maximum photic usage, and higher photic usage rate can be produced with thin liquid crystal cavity gap thickness.
2. Liquid crystal molecules requires relatively short time between the period from rising to descending, and with thin liquid crystal cavity gap, relatively low voltage can be used for liquid crystal driving. Since they are driven with low voltage, it is relatively beneficial for low electric power consumption, and makes design of electronic control circuits easy.
3. They are easy to assemble and have thin cell gaps, and gap particles are normally used to maintain the evenness of cell gap. Cell gap is widely used in liquid crystal display industry. The smaller gap separating particles used are easy to obtain and control in manufacturing processes.

However, in certain application fields, thicker liquid crystal layer is necessary but problems associated with driving are often encountered.

In a nematic liquid crystal device, the relationships of rise time (Tᵣᵢₛₑ) and decay time (T_{decay}) with respect to liquid crystal cavity cap (d), rotational viscosity (γ), elasticity coefficient (K), critical voltage (Vₜₕ), bias voltage (V_{b}) and total applied voltage (V) are as follows:

$${T}_{rise} = \frac{γ {d}^{2} / K {π}^{2}}{{( 0 / Vth )}^{2} - 1}$$

$${T}_{decay} \frac{γ {d}^{2} / K {π}^{2}}{\vert {( {V}_{b} / Vth )}^{2} - 1 \vert}$$

However, if the liquid crystal cavity gap increases to 30 μm, 50 μm, 100 μm or wider, the response time will become very slow and even unable to switch all liquid crystal cavities.

FIG. 1 and FIG. 2 show A typical driving manner of known LCD panel, wherein the common electrode 2 of the liquid crystal panel 1 is inputted with a common voltage Vcom through a driving circuit 3. The waveform of the common voltage Vcom is as shown in FIG. 2 and the common voltage Vcom is fixed to adapt to the characteristics of the liquid crystal molecules, and its normal period point is at 5V or 3.3V.

As shown in the known common voltage Vcom in FIG. 2, the driving manner of the common electrode (Vcom AC Modulation) is such that when the voltage of the common electrode is fixed, the maximum voltage at the display electrode has to reach more than two times of the voltage of the common electrode. If the voltage of the common electrode is fixed for example at 5V, the range of working voltage that can be provided by the source driver will be higher than 10V. However, if the voltage of the common electrode is varied, and assuming the maximum voltage of the common electrode is 5V, then a maximum working voltage of 5V should be adequate for the source driver. Higher range of working voltage will render to higher circuit complexity, and power will also be increased.

As liquid crystal cavity gap thickness (d) in the above formula is to the power of two, the response time becomes very slow. A common way to resolve response time problem is by reducing the rotational viscosity of the liquid crystal material, reducing the liquid crystal cavity gap thickness (d), and applying higher voltage. However, it will contribute to poor clairvoyance rate, low contrast, color defects and side effects, and this will render to larger quantity of thicker liquid crystal devices being used and cause more negative consequences resulting in inability to meet production demand.

In addition, a FIG. 3 and FIG. 4 show a waveform of another double duty current (DDC) driving method, wherein the driving signal waveform comprises an AC drive waveform A1 and an AC pulse A2 with smaller fixed working period, and which can reduce switching time of liquid crystal materials, but this display data channel driving method is different from the known overdriving or pre-driving methods. As these known driving methods use AC pulse A2 signal with fixed working period and basic AC drive waveform A1, they require re-plotted signal voltage and modified signal waveform A3 (as shown in FIG. 4) to be achieved through other integrated circuits, and the common electrode waveform will be associated with shift and the negative effects of which are color shift, non-linear grey scale, color deviation, flickering and other poor image quality problems.

Besides that, in the aspect of patent literature of previous patents, for example, U.S. Pat. No. 5,764,324 males the work function between the aluminum metallic layer and the electrode to be near a stable state to avoid flickering by deploying other substances and materials, e.g. by deploying one or more layers of transparent conductive materials and electro-medium materials between the aluminum reflection layer and the opposing electrode. The reflection metallic layer and the opposing electrode material are used to select the near-stable work function of the reflective metal and the opposing electrode.

However, in the US invention patent mentioned above, material with as high reflectivity as possible (aluminum-silver alloy) must be selected for used in the reflective metal layer, and silver has a wider work function range of 4.36 eV 4.74 eV than ITO (Indium Tin Oxide) whose work function range is 4.7 eV. In any case, silver is relatively unstable and very difficult to handle, and aluminum is the best material for use in reflection metallic layer, but the work function range of aluminum (4.06 eV˜4.41 eV) cannot match the work function of ITO (Indium Tin Oxide) (4.7 eV).

### SUMMARY OF TEE INVENTION

Therefore, the objective of this invention is to provide an optimized driving method for thick liquid crystal cavity gap (thick cell) type liquid crystal panel, and in particular, to an optimized driving method that can be applied for the driving of thick liquid crystal cavity gap (thick cell) type liquid crystal panel and for achieving a response time two times faster than that of known driving manner.

Another objective of this invention is to an optimized driving method for thick liquid crystal cavity gap (thick cell) type liquid crystal panel, wherein the driving signal waveform needs not be altered, and no re-plotted driving signal voltage and modified signal waveform is required.

A further objective of this invention is to an optimized driving method for thick liquid crystal cavity gap (thick cell) type liquid crystal panel, wherein the excursion of common voltage of the common electrode of the thick liquid crystal cavity gap (thick cell) type liquid display panel can be easily compensated, and the display quality of the display panel can be ensured.

To achieve the said objectives, the optimized driving method for thick liquid crystal cavity gap (thick cell) type liquid crystal panel of this invention is used, wherein a second DC or AC adjustable-period or tunable power source is applied to drive the common electrode of the LCD panel so as to minimize voltage excursion without having to alter signal, and wherein data signals pass through TFT-type data driver, thereby making the work function between the aluminum metallic layer and the electrode of liquid crystal display panel to be near a stable state to avoid quality problems associated with image flickering, in order to cause the thick liquid crystal cavity gap (thick cell) type liquid crystal panel to have faster response time and to achieve the intended effect of the invention of optimizing image display quality without having to alter driving signal waveform.

### BRIEF DESCRIPTION OF THE DRAWINGS

FIG. 1 is a diagram showing a driving configuration of known LCD panel.

FIG. 2 is a diagram showing a driving signal waveform of known LCD panel.

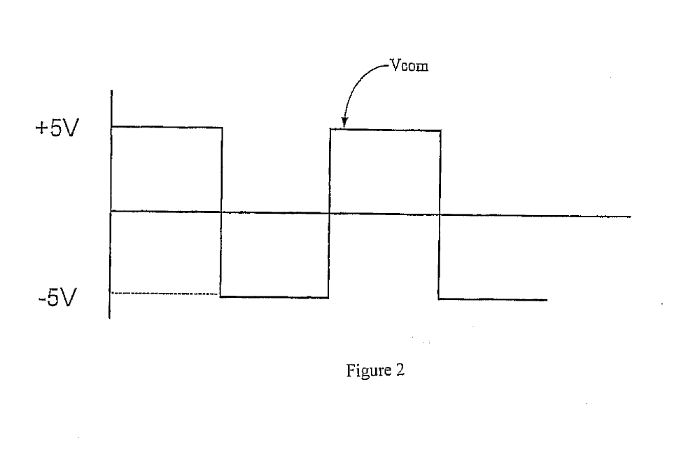

FIG. 3 is a diagram showing a driving signal waveform of renown display data channel driving method.

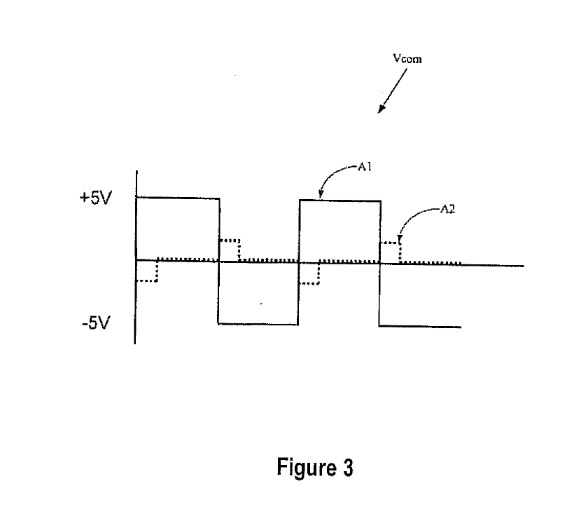

FIG. 4 is a diagram showing a re-plotted signal voltage and modified signal waveform of known display data channel driving method.

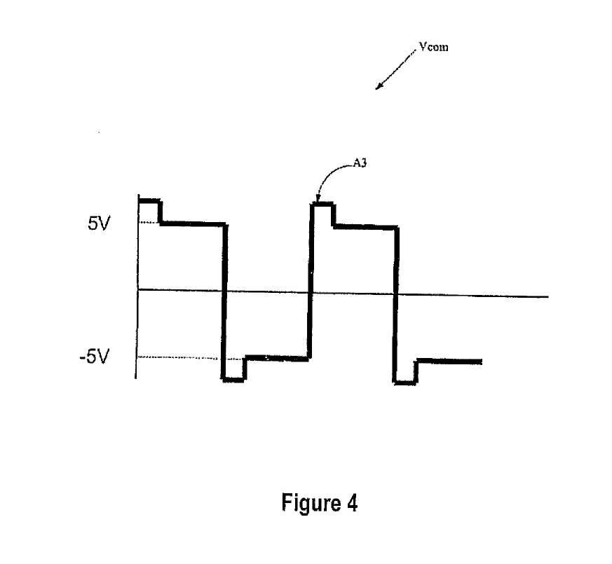

FIG. 5 is a flow chart of the optimized driving, method for thick liquid crystal cavity gap (thick cell) type liquid crystal panel of this invention.

FIG. 6 is a diagram showing the driving signal waveform of FIG. 5.

FIG. 7 is a diagram showing another implementation example of this invention.

FIG. 8 is a diagram showing the response time curves of the driving method of this invention and known driving method.

### DETAILED DESCRIPTION OF TEE PREFERRED EMBODIMENTS

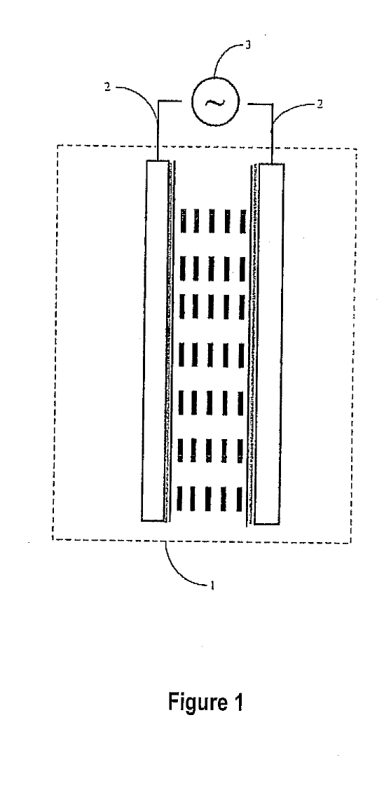

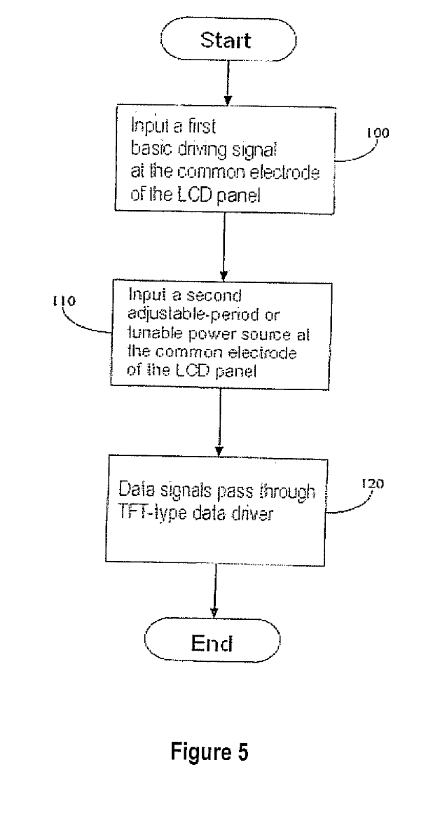

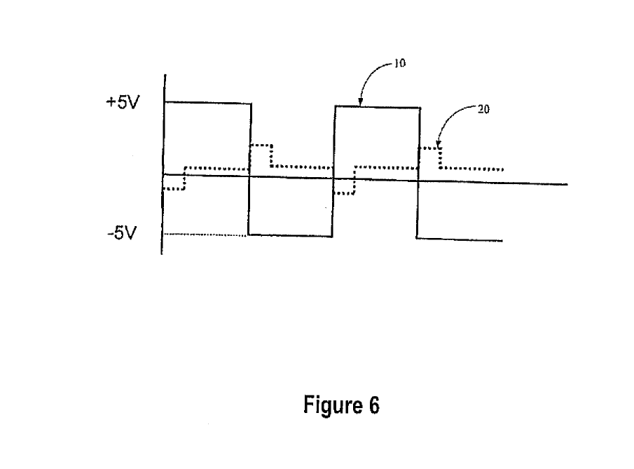

Referring to FIG. 5 and FIG. 6 showing the optimized driving method for thick liquid crystal cavity gap (thick cell) type liquid crystal panel of this invention includes steps 100˜120, wherein:
(100) Input a first basic driving signal at the common electrode of the LCD panel, input a first basic driving signal 10 at the common electrode of a thick liquid crystal cavity gap (thick cell) type LCD panel, and waveform of the first basic driving signal 10 is as shown in FIG. 6 and the input method for the signal is as shown in FIG. 1.
(110) Input a second adjustable-period or tunable power source at the common electrode of the LCD panel, i.e. input a second power source 20 (as shown in FIG. 6) at the common electrode of step 100, wherein the second power source 20 is a DC or AC adjustable-period or tunable power source.
(120) Data signals pass through TFT-type data driver, i.e. the data signals of the thick liquid crystal cavity gap (thick cell) type LCD panel of step 100 pass through a TFT-type data driver, as in the case of display data channel (DDC) driving method.

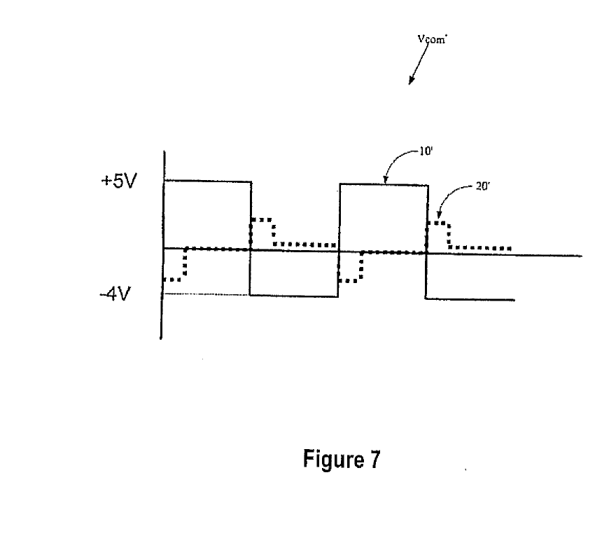

Referring also to FIG. 7 that shows another implementation example of this invention, wherein the state of a LCOS (Liquid Crystal on Silicon) type thick liquid crystal cavity gap (thick cell) type LCD panel is illustrated. The LCOS (Liquid Crystal on Silicon) comprises two basic components, one of which is glass and the other is wafer, and working manner of which is different from flickering manner. If the driving frequency of the first basic driving signal 10′ is 60 Hz, then the flickering, frequency is 30 Hz. In this invention, the working period of the second power source 20′ is adjusted in order to reduce the range of excursion (displacement) of the common voltage Vcom′ of the work function of silicon back-light plate to be within 1,000 mV. That is to say, by using the method of this invention for driving the LCOS (Liquid Crystal on Silicon) type thick liquid crystal cavity gap (thick cell) type LCD panel, the driving signal waveform needs not be altered so that undesirable error functions are avoided.

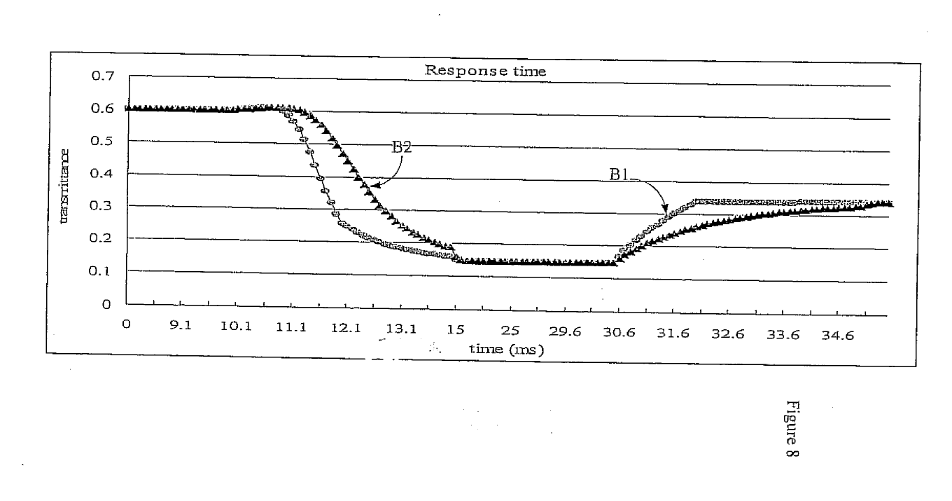

Referring, also to FIG. 8 that shows an actual data curve comparison diagram of the optimized driving method for thick liquid crystal cavity gap (thick cell) type liquid crystal panel of this invention, wherein a curve of analog response time versus response time of driving of a connatural liquid crystal wafer with a clairvoyance rate of 550 mμm (mili-micrometer). The critical voltage is approximately Vᵣₘₛ (root mean square), the liquid cavity gap is approximately 1.25 μm, the vertical axis represents clairvoyance rate while the horizontal axis represents response time. In the diagram, the portion with round dots (i.e. 1st curve B1) represents driving using the method of this invention, the triangular portion (i.e. 2nd curve B2) represents driving using known driving method. The main comparisons between their respective rise times (Tᵣᵢₛₑ) and decay times (T_{decay}) are as follows:

| Response Time | First Curve - B1 | Second Curve - B2 |
|---|---|---|
| Rise Time | 2.6 ms | 3.6 ms |
| Decay Time (T_{decay}) | 1.2 ms | 4.2 ms |
| Total | 3.6 ms | 7.8 ms |

From FIG. 8 and the above tables, it can be obviously seen that the response time of the 1st curve B1 is two times faster that the response time of the 2nd curve B2. In other words, the method of this invention is two times faster than known driving method.

The descriptions and figures of the optimized driving method for thick liquid crystal cavity gap (thick cell) type liquid crystal panel of this invention as shown in FIG. 5 to FIG. 8 are intended to illustrate the technical contents and technical means of this invention. The implementation examples disclosed herein shall not limit the scope of this invention. In addition, any modifications or alterations made to the details of configuration of this invention, or any equivalent substitutions, replacements of the components do not depart from the spirit and scope of this invention, and the scope of this invention shall be defined by the following patent claim scope.

1. An optimized driving method for thick liquid crystal cavity gap (thick cell) type liquid crystal panel, the steps of which comprising:
(a) Input a first basic driving signal at the common electrode of the LCD panel, i.e. input a first basic driving signal at the common electrode of a thick liquid crystal cavity gap (thick cell) type LCD panel;
(b) Input a second adjustable-period or tunable power source at the common electrode of the LCD panel, i.e. input a second power source at the common electrode of step (a), wherein the second power source is an adjustable-period or tunable power source; and
(c) Data signals pass through TFT-type data driver, i.e. the data signals of the thick liquid crystal cavity gap (thick cell) type LCD panel of step (a) pass through a TFT-type data driver.

2. A method for forming thick cell cavity gap of liquid crystal panel as defined in patent claim scope 1, wherein the second power source of step (b) is an AC adjustable-period or tunable power source.

3. A method for Forming thick cell cavity gap of liquid crystal panel as defined in patent claim scope 1, wherein the second power source of step (b) is an DC adjustable-period or tunable power source.
